(19) United States
(12) Patent Application Publication
(10) Pub. No.: US 2024/0331561 A1
(43) Pub. Date: Oct. 3, 2024

(54) CURRICULUM CHALLENGE EVALUATION

(71) Applicant: International Business Machines Corporation, Armonk, NY (US)

(72) Inventors: Martin G. Keen, Cary, NC (US); Jeffrey Bisti, New Paltz, NY (US); Kriti Kamra, Markham (CA); Mark Bylok, Toronto (CA)

(21) Appl. No.: 18/191,908

(22) Filed: Mar. 29, 2023

(51) Int. Cl. G09B 7/02

(52) U.S. Cl. CPC G09B 7/02

(57) ABSTRACT

Disclosed embodiments provide techniques for automated evaluation and scoring of curriculum challenges such as tests and quizzes. An automated score is provided to students, as well as prescriptive guidance on where the provided solution deviates from best practices and/or the taught curriculum. Curriculum material and challenge material are input to a machine learning system to create a grading model. The challenge material can include a software programming challenge. The grading model is used to evaluate curriculum responses and provide a score and feedback based on the evaluation. The evaluation can be based on the curriculum. There can be multiple ways to solve a programming (coding) challenge and disclosed embodiments give scoring preference to solutions that employ techniques covered in the curriculum.

### FIELD

The present invention relates generally to computerized document analysis, and more particularly, to curriculum challenge evaluation.

### BACKGROUND

Remote learning, also known as online learning or e-learning, has become increasingly popular in recent years. One of the biggest advantages of remote learning is its flexibility. Students can access course materials and complete assignments at their own pace and according to their own schedule. This can be particularly beneficial for students who work or have other commitments that make attending traditional classes difficult. Additionally, remote learning allows students to attend classes from anywhere with an internet connection, which can save time and money on commuting and housing costs. This can also be quite helpful for students who live in remote or rural areas and may not have access to traditional educational institutions. Remote learning can be instructor-led, or asynchronous. Asynchronous remote learning is self-paced and allows students to do their assignments at a time of day that suits them. Thus, remote learning can be well-suited for students who require flexibility due to work and other commitments.

Some subjects are better suited to remote learning than others. In particular, instruction of programming languages, such as C, Python, Java, and the like, are well-suited to asynchronous remote learning. Students can review lesson material, and submit programing assignments and take quizzes and tests online. The quizzes and tests can be graded to provide an assessment of how well the student is learning and understanding the material.

### SUMMARY

In one embodiment, there is provided a computer-implemented method comprising: obtaining curriculum material from a curriculum material corpus; obtaining challenge material from a challenge corpus; inputting the curriculum material and the challenge material to a machine learning system; creating a curriculum grading model based on the machine learning system; evaluating a curriculum response using the curriculum grading model, and generating a score based on the evaluating.

In another embodiment, there is provided an electronic computation device comprising: a processor; a memory coupled to the processor, the memory containing instructions, that when executed by the processor, cause the electronic computation device to: obtain curriculum material from a curriculum material corpus; obtain challenge material from a challenge corpus; input the curriculum material and the challenge material to a machine learning system; create a curriculum grading model based on the machine learning system; evaluate a curriculum response using the curriculum grading model; and generate a score based on the evaluating.

In yet another embodiment, there is provided a computer program product for an electronic computation device comprising a computer readable storage medium having program instructions embodied therewith, the program instructions executable by a processor to cause the electronic computation device to: obtain curriculum material from a curriculum material corpus; obtain challenge material from a challenge corpus; input the curriculum material and the challenge material to a machine learning system; create a curriculum grading model based on the machine learning system; evaluate a curriculum response using the curriculum grading model; and generate a score based on the evaluating.

### BRIEF DESCRIPTION OF THE DRAWINGS

FIG. 1 is an exemplary computing environment in accordance with disclosed embodiments.

FIG. 2 is an exemplary ecosystem in accordance with disclosed embodiments.

FIG. 3 is a flowchart indicating process steps for embodiments of the present invention.

FIG. 4 is a flowchart indicating process steps for additional embodiments of the present invention.

FIG. 5 is a flowchart indicating additional process steps for additional embodiments of the present invention.

FIG. 6 is an example of source code preprocessing.

FIG. 7 is an example of parameter randomization.

FIG. 8 is an example curriculum challenge and corresponding curriculum response.

FIG. 9 shows an exemplary score based on the evaluation of the curriculum response of FIG. 7.

FIG. 10 shows another exemplary score based on the evaluation of another curriculum response.

FIG. 11 shows another exemplary score based on the evaluation of another curriculum response.

FIG. 12 shows another exemplary score based on the evaluation of another curriculum response that includes curriculum material.

FIG. 13 shows an example of appraisal mode.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Grading software coding assignments can present a number of challenges. For one, grading software assignments can be subjective because there may be multiple ways to solve a problem or complete a task. This can make it difficult to assign grades consistently across different students or assignments. Additionally, grading software assignments can be time-consuming, especially if the code is complex or if the assignment requires manual testing. This can be a significant challenge for instructors who have to grade a large number of assignments. Another challenge in grading software assignments is plagiarism. It can be difficult to determine if a student has plagiarized code or used external resources to complete an assignment. This can make it challenging to assign accurate grades. Furthermore, grading of software assignments often provides limited feedback to students on how to improve their coding skills or what specific mistakes they made. This can limit the opportunity for students to learn from their mistakes and improve their skills.

Digital online learning platforms include a combination of remote learning techniques such as video, demonstrations, and hands-on lab exercises. The majority of these learning experiences are conducted asynchronously, meaning a student may work on a lab exercise independently from when an instructor is supervising a course. Many digital online learning platforms utilize quizzes with multiple choice selections. These quizzes are defined ahead of time by an instructor, and can easily be graded automatically by the digital online learning platform. However, other student work is more subjective and cannot be so easily graded.

As an example, a course can provide a lab exercise that requests a student to submit a portion of code to read items from a table and display those items to the screen sequentially. There may be many different ways to achieve this output. Grading the student's work from the output alone is insufficient as it does not reflect the method that they used to achieve the output. One student may utilize coding best practices while another may use poor naming standards, GOTO loops, and confusing indentation. In addition, a black market has developed for the sale of answers to student exercises. This can facilitate cheating, which is bad for the students, as well as the institution. It is therefore desirable to have improved techniques for automatically grading asynchronously created student work.

Disclosed embodiments provide techniques for automated evaluation and scoring of curriculum challenges such as tests and quizzes. An automated score is provided to students, as well as prescriptive guidance on where the provided solution deviates from best practices and/or the taught curriculum. Curriculum material and challenge material are input to a machine learning system to create a grading model. The grading model is used to evaluate curriculum responses and provide a score and feedback based on the evaluation. The evaluation can be based on the curriculum. This is important since there can be multiple ways to solve a programming (coding) challenge, but it is ideal to give scoring preference to solutions that employ the techniques covered in the curriculum.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

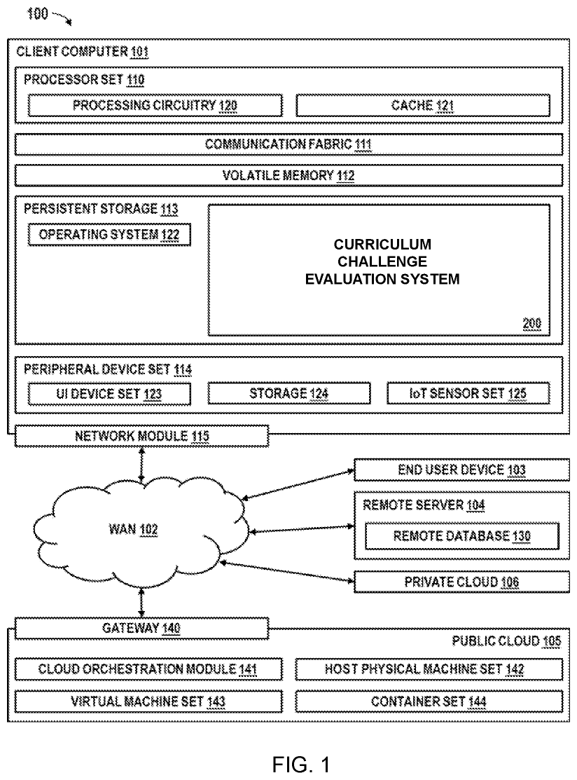

FIG. 1 shows an exemplary computing environment 100 in accordance with disclosed embodiments. Computing environment 100 contains an example of an environment for the execution of at least some of the computer code involved in performing the inventive methods, such as curriculum challenge evaluation system block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

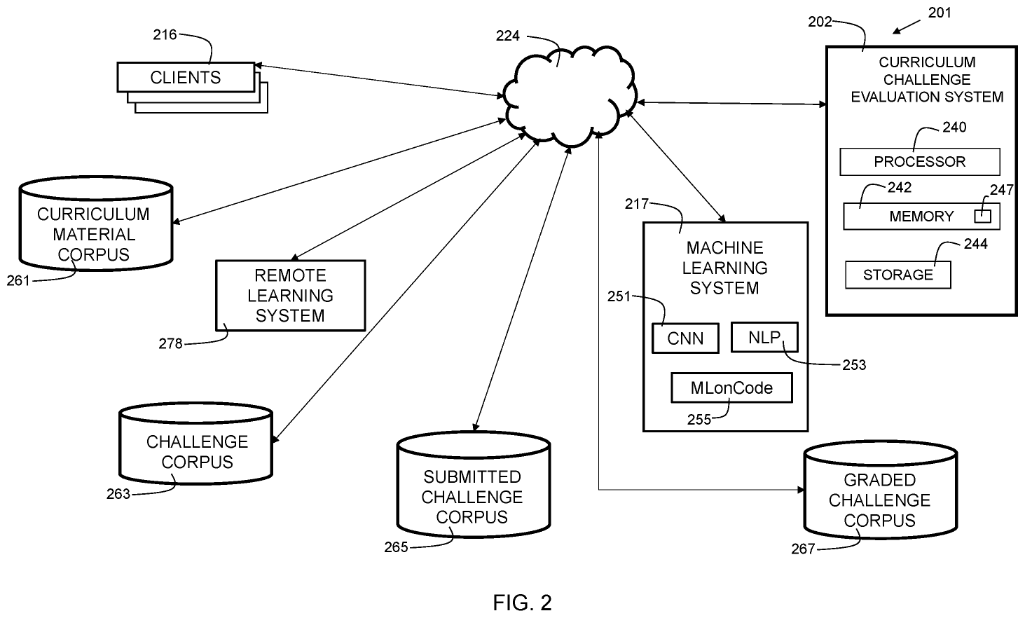

FIG. 2 is an exemplary ecosystem 201 in accordance with disclosed embodiments. Curriculum Challenge Evaluation System (CCES) 202 comprises a processor 240, a memory 242 coupled to the processor 240, and storage 244. CCES 202 is an electronic computation device. The memory 242 contains program instructions 247, that when executed by the processor 240, perform processes, techniques, and implementations of disclosed embodiments. Memory 242 can include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 244 may include one or more magnetic storage devices such as hard disk drives (HDDs). Storage 244 may additionally include one or more solid state drives (SSDs). The CCES 202 is configured to interact with other elements of ecosystem 201. CCES 202 is connected to network 224, which is the Internet, a wide area network, a local area network, or other suitable network.

Ecosystem 201 may include a remote learning system 278. The remote learning system 278 can include servers and backend applications for hosting and providing online lessons and an online portal for submitting homework, taking tests and quizzes, and/or other activities for promotion of learning and assessment of educational material.

Ecosystem 201 may include one or more client devices, indicated as 216. Client device 216 can include a laptop computer, desktop computer, tablet computer, or other suitable computing device. Client device 216 may be used to interact with remote learning system 278 to enable end-users to participate in online courses, including, but not limited to, online programming courses. The programming courses can present education material and provide assessments for languages such as C, C++, Python, bash, Java, JavaScript, and/or other programming languages. Additionally, client device 216 may be used to configure features in the CCES 202, including features such as training and evaluating of grading models.

Ecosystem 201 may include machine learning system 217. The machine learning system 217 can include a convolutional neural network (CNN) 251, a natural language processing (NLP) module 253, and/or a MLonCode (Machine Learning on Code) module 255. MLonCode (Machine Learning on Code) refers to the use of machine learning techniques to analyze and understand code. MLonCode aims to improve software development processes by automating various tasks such as code review, bug detection, code completion, and refactoring. MLonCode algorithms can be used to classify code according to its type, purpose, or functionality. This can be useful for organizing and searching code repositories, and for identifying patterns or trends in code usage. MLonCode algorithms can be used to detect bugs or errors in code by analyzing its syntax and structure. This can help developers to identify and fix bugs more quickly and efficiently. MLonCode algorithms can be trained to identify opportunities for code refactoring, which can improve code quality and maintainability. This can save time for developers by automating the process of identifying and addressing issues in code. In embodiments, MLonCode can be used to improve code quality, reduce development time, and enhance the overall efficiency of software development processes.

Natural Language Processing (NLP) is a subfield of Artificial Intelligence (AI) and computational linguistics that deals with the interaction between humans and computers using natural language. It involves the development of algorithms and computational models that can analyze, understand, and generate human language. NLP enables computerized analysis of the meaning of human language by using a variety of techniques such as text analysis, text classification, sentiment analysis, named entity recognition, machine translation, and/or other suitable techniques.

In some embodiments, the machine learning system 217 may include a Support Vector Machine (SVM), Decision Tree, Recurrent Neural Network (RNN), Long Short Term Memory Network (LSTM), Radial Basis Function Network (RBFN), Multilayer Perceptron (MLP), and/or other suitable neural network type. In embodiments, the machine learning system 217 is trained using supervised learning techniques. The supervised learning techniques can include supplying curriculum responses that are marked as correct or incorrect. The machine learning system 217 ‘learns’ what a correct curriculum response contains, and once trained, can provide effective feedback for remote learning students that are learning a programming language.

Ecosystem 201 includes a curriculum material corpus 261. The curriculum material corpus 261 can include digital assets such as text, audio, images, video, and/or interactive content. The curriculum material corpus 261 may utilize a database, such as a SQL database, to store and/or index the content within the curriculum material corpus 261. The content within the curriculum material corpus 261 may be organized into chapters, lessons, subchapters, etc. In embodiments, the curriculum material corpus includes text, audio, and/or at least one image.

Ecosystem 201 includes a challenge corpus 263. The challenge corpus 263 includes a collection of tests, quizzes, homework problems, and the like. The challenge corpus 263 may utilize a database, such as a SQL database, to store and/or index the content within the challenge corpus 263. The content within the challenge corpus 263 may be organized into chapters, lessons, subchapters, etc.

Ecosystem 201 includes a submitted challenge corpus 265. The submitted challenge corpus 265 includes a collection of tests, quizzes, homework problems, and the like. The submitted challenge corpus 265 may utilize a database, such as a SQL database, to store and/or index the content within the submitted challenge corpus 265. The content within the submitted challenge corpus 265 may be organized into chapters, lessons, subchapters, etc. The content within the submitted challenge corpus 265 comprises challenges from the challenge corpus 263 that have been completed.

Ecosystem 201 includes a graded challenge corpus 267. The graded challenge corpus 267 includes a collection of tests, quizzes, homework problems, and the like. The graded challenge corpus 267 may utilize a database, such as a SQL database, to store and/or index the content within the graded challenge corpus 267. The content within the graded challenge corpus 267 may be organized into chapters, lessons, subchapters, etc. The content within the graded challenge corpus 267 comprises challenges from the challenge corpus 263 that have been completed and graded.

The challenges can have metadata associated with them. The metadata can include scoring from a human grader. Sets of training data can be based on submitted challenges from the submitted challenge corpus that have been graded by humans. Once trained, an additional set of submitted challenges can be evaluated and the results can be compared with the scores in the associated metadata, to determine if the CCES 202 is grading challenges effectively.

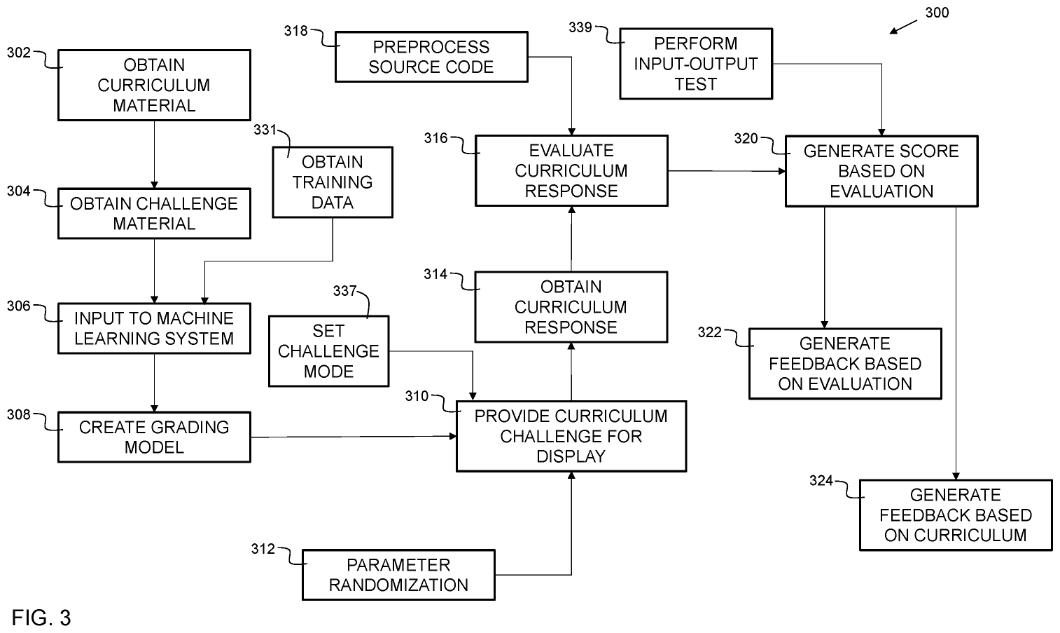

FIG. 3 is a flowchart 300 indicating process steps for embodiments of the present invention. At 302, curriculum material is obtained. Referring additionally to FIG. 2, in embodiments, the curriculum material is obtained from the curriculum material corpus 261. The curriculum can include text, audio, still images, videos, and/or other forms of content. In embodiments, the CCES 202 may perform an ingest process on the curriculum material that is obtained. The ingest process can include indexing, identifying chapters and/or subchapters, identification of keywords utilizing Bag of Words (BoW), TF-IDF (Term Frequency Inverse Data Frequency), and/or other suitable techniques.

At 304, challenge material is obtained. In embodiments, the challenge material is obtained from the challenge corpus 263. The challenges can include tests, quizzes, homework assignments, and/or other challenges. The challenges can include questions, word problems, multiple choice problems, and so on. The challenge material obtained at 304 comprises the challenge questions/assignment, but may not include any answers provided by students.

At 331, training data is obtained. The training data can include challenge material such as obtained at 304, that also include answers (responses) to the challenge material. The training data can include a mix of correct and incorrect answers. The training data can include answers of varying levels of correctness. The training data can have metadata associated with it. The metadata can include grading and/or scoring from human graders. The training data can be used to train the machine learning system 217 (FIG. 2) for grading of programming language coding assignments, in accordance with embodiments of the present invention.

At 306, the curriculum material, challenge material, and training data is input to a machine learning system. The machine learning system can perform natural language processing, entity detection, disambiguation, and/or other processes to determine the programming techniques to be taught with the curriculum material. Since programming language challenges can often be performed using a variety of techniques, there can be multiple approaches that can generate a correct answer. However, disclosed embodiments can emphasize the solution that is in accordance with the curriculum, providing a richer, and more meaningful automatic grading system for software coding assignments. As an example, there are multiple techniques for sorting an unordered list of numbers. A challenge that asks a student to write a program to sort an unordered list of numbers may be solved by implementing a bubble sort algorithm. A student who implements the bubble sort algorithm may ultimately obtain the correct answer. However, if the lesson curriculum is covering the quick sort algorithm, and that is the preferred technique for the challenge, then disclosed embodiments can award a higher score for the solution that uses the quick sort algorithm, as compared with a bubble sort algorithm.

At 308, a grading model is obtained, based on the training data, curriculum material, and challenge material. At 310, a curriculum challenge is provided for display. The curriculum challenge can include a question, coding assignment, and/or other test of knowledge. As an example, the curriculum challenge can provide an assignment such as “write a C program to accept a first name and last name, and save it to a text file, along with a 6-digit random number.”

At 314, a curriculum response is obtained. The curriculum response can include a student's answer to the challenge. It can include a code snip, a full program, written sentences, and/or other elements. Optionally, at 337, a challenge mode is set. The challenge mode can establish the behavior of the CCES within a student portal for completing responses to curriculum challenges. In embodiments, providing the curriculum challenge for display includes setting a challenge mode. In embodiments, the challenge mode can include a test mode, and an appraisal mode. Other modes are possible in disclosed embodiments. The appraisal mode can be used for quizzes, homework, and preliminary knowledge checks. The appraisal mode may analyze source code in near real time, as the user enters it. The appraisal mode may include displaying hints and/or a score as the user enters the response, giving feedback to the user that he or she can use to make changes to the response prior to submission. The test mode can be used for taking tests, and provides no clues or hints to the user. In embodiments, the appraisal mode is used for initial challenges and homework problems, while the test mode is used when administering tests that count towards the final grade of a programming course.

Optionally, at 312, parameter randomization is performed. Embodiments can include performing a parameter randomization on the curriculum challenge. With the advent of the internet, the answers to many programming challenges can be found online, which makes it more convenient for students to potentially cheat by copying solutions. With parameter randomization, certain details of the challenge are changed for each course, each student, and/or other criteria for changing parameters. As an example, a base curriculum challenge may state: “Write a C program to accept a first name and last name, and save it to a text file, along with a 6-digit random number.” With parameter randomization, that challenge can be changed to: “Write a C program to accept a city and state, and save it to a text file, along with a 4-digit random number.” The same basic principles can be used to respond to both challenges. However, by changing the challenge via parameter randomization, it can foil pure copying of a solution from the internet. In some embodiments, the parameter randomization can include selecting, at random, an element from a list of elements to replace in a given location within a curriculum challenge.

At 316, the curriculum response is evaluated. The evaluation can be based on keywords used in the response, the use of variables, the naming of the variables, and so on. Additionally, NLP may be used on comments included in the source code provided in the response, in order to further determine the intention and/or context of the submitted source code.

Optionally, at 318, the source code is preprocessed. The preprocessing can include performing entity detection on comments, identifying programming keywords, identifying variables, performing token splitting and/or token normalization, and/or other preprocessing operations. In embodiments, the evaluating includes preprocessing of source code.

At 320, a score is generated based on the evaluation by the grading model. In some embodiments, the score can be a numerical value having a range from zero to 100, where 100 is the best possible score. The score can be provided to the student and/or instructor as part of an automated assessment of a software coding assignment.

Optionally, at 339, an input-output test is performed. In embodiments, this can include providing one or more sets of inputs to an executable program, where the executable program is compiled from, or otherwise based on, source code submitted by a student as a curriculum response. The input-output test can be performed using a unit test framework. The framework used may depend on the programming language being tested. Example frameworks can include, but are not limited to, CUnit, CppTest, CppUnit, Junit, JSUnit, Pytest, and/or other suitable testing frameworks. Thus, embodiments can include performing an input-output test on an executable based on the curriculum response. In embodiments, a set of inputs are provided to the program and the resulting outputs are compared with a reference output. If the resulting output matches the reference output, then the program is deemed to have provided the correct result.

The process continues at 322 with generating feedback based on the evaluation. The feedback can include the score generated at 320, as well as hints, tips, and/or other corrections based on output from the grading model created at 308. Optionally, at 324, feedback is generated based on the curriculum material obtained at 302. The feedback can include an indication of how well the student used techniques taught in the curriculum to solve the curriculum challenge.

Effective grading of software coding assignments is more than simply checking for a correct result from a student's program. In general, it is intended that a student solve a coding problem using a concept being taught in a lesson. Disclosed embodiments provide a comprehensive set of features for effective automated grading of curriculum challenges such as software coding assignments. The parameter randomization feature inhibits the ability of students to cheat by finding the exact solution online. The input-output test checks that the program functions as intended. The machine learning system, including MLonCode, analyzes the code and determines if the correct keywords were used, and in the expected sequence. In addition to detecting if the program provides the correct result, disclosed embodiments can also evaluate how closely the student's submitted answer reflects best practices, as taught in the curriculum material.

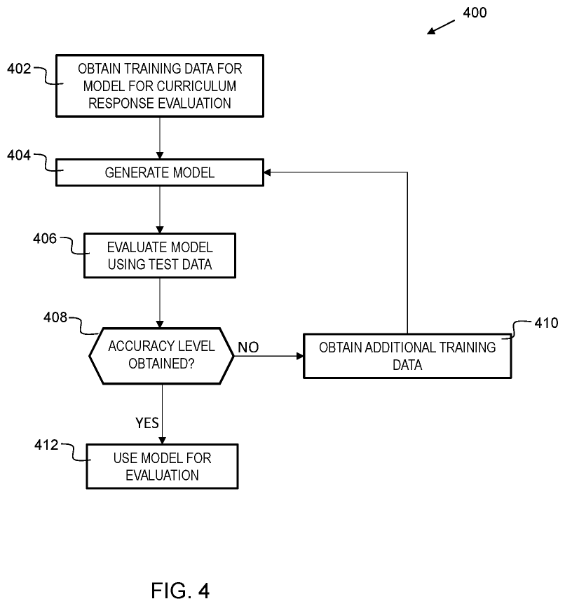

FIG. 4 is a flowchart 400 indicating process steps for additional embodiments of the present invention. At 402, training data for a machine-learning model for curriculum response evaluation is obtained. The training data can include labeled responses. The labeled responses can be completed responses indicated as correct or incorrect and can be used to train the model using supervised learning techniques. In embodiments, the curriculum grading model is based on a plurality of correct solutions and a plurality of incorrect solutions.

At 404, the model is generated based on the training data. At 406, the model is evaluated using test data. The test data can include a collection of labeled responses. The labeled responses can include both correct and incorrect solutions. The labeled responses may be evaluated manually for the purposes of labeling. Then, the labeled responses are input to the model, and the results from the model are compared with labeled metadata. Ideally, the model should evaluate as correct, all labeled responses with metadata indicating a correct response. Similarly, the model should evaluate as incorrect, all labeled responses with metadata indicating an incorrect response. In practice, there can be some instances where the model evaluates as correct, a labeled response with metadata indicating an incorrect response. This failure to flag an incorrect response is referred to as a false negative. Similarly, there can be some instances where the model evaluates as incorrect, a labeled response with metadata indicating a correct response. This flagging of a correct response as incorrect is referred to as a false positive. At 408, a check is made to determine if a desired accuracy level is obtained. In embodiments, the desired accuracy level can be specified as achieving a false positive rate and/or false negative rate below a predetermined threshold (e.g., below five percent). If yes at 408, the process continues to 412 where the model is put in use for evaluation, such as automatic grading of student's software coding assignments. If no at 408, then the process continues to 410, where additional training data is obtained, and the process then returns to 404 to retrain the model using the additional training data. The steps of 404 to 408 can be performed in multiple iterations until the desired accuracy level is obtained.

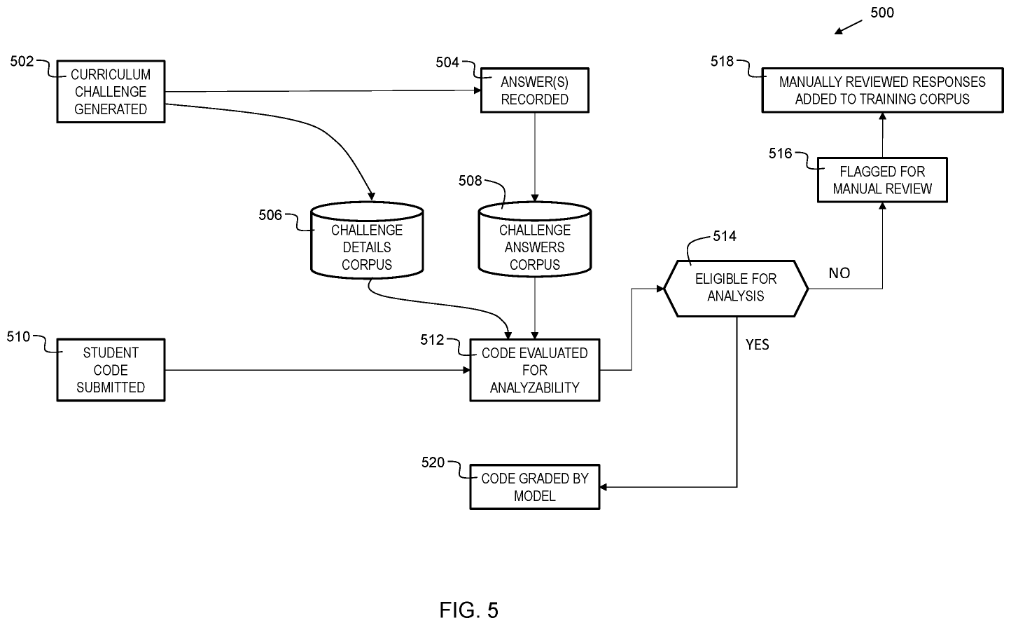

FIG. 5 is a flowchart 500 indicating additional process steps for additional embodiments of the present invention. At 502, a curriculum challenge is generated. The curriculum challenge can be based on subject matter in a section of curriculum, such as a chapter, subchapter, or the like. At least one correct answer is recorded at 504. In embodiments, multiple correct answers are recorded at 504. In some embodiments, one or more incorrect answers are also recorded at 504. The recorded answers are stored in the challenge answers corpus 508. The curriculum challenge is stored in challenge details corpus 506. At 510, student code is submitted. At 512, the code is evaluated for analyzability. The evaluation can include testing that code compiles and executes, and that it produces a result. If, at 514 it is determined that the student code submitted at 510 is eligible for analysis, then the process continues to 520, where the student's submitted code is graded by the artificial intelligence (AI) model that was trained as previously described and shown in FIG. 4. If no at 514, then the process optionally continues to 516 where the response is flagged for manual review. In embodiments, this can include sending the flagged response in an email or providing a link to the flagged response in a portal for an instructor to review. Optionally, at 518, the manually reviewed responses are included in the training corpus. This enables a continuous learning process for models of disclosed embodiments. As more students generate responses, responses that are not understood or correctly evaluated by the model can be manually evaluated and used as retraining material for the grading model to further refine its capabilities. In one or more embodiments, the responses flagged at 516 are reviewed by an additional machine-learning system, instead of, or in addition to, the manual evaluation, and the evaluation results from the additional machine-learning system are used as training input for the grading model (308 of FIG. 3).

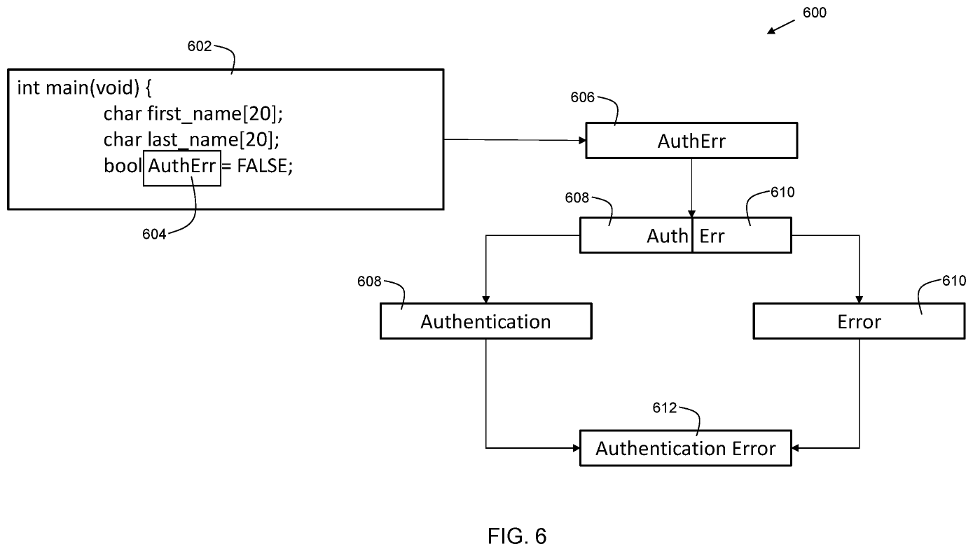

FIG. 6 is an example 600 of source code preprocessing. At 602 a snip of C code is shown, which contains a variable “AuthErr” as indicated at 604. The preprocessing can include tokenizing the snip of C code, and extracting the variable at 606, using lexical analysis, compiler intermediate files such as symbol tables, and/or other suitable techniques. The variable ‘AuthErr’ at 606 is then split into two fragments, as indicated at 608 and 610. The splitting can be based on capitalization of letters within the token, identification of delimiters, such as an underscore, identification of common word stems, and so on. The processing can further include normalization, in which the fragments are converted to words. This enables a many-to-one mapping to collapse the fragments to a single value. As an example, the fragments ‘Auth,’ ‘Authen.’ And ‘Authenticate’ can all map to ‘Authentication.’ Additionally, misspelled variables may also be mapped to the value. As an example, a variable ‘Authentication’ may also be mapped to the value ‘Authentication.’ In this way, machine learning algorithms such as NLP and/or MLonCode can operate on the mapped value. In some embodiments, the mapped values may be recombined, such as shown at 612, to form a compound value. In the example of FIG. 6, the compound value is ‘Authentication Error.’ This context can be used to enable the machine learning grading algorithms to interpret the context of a variable and evaluate it accordingly. In embodiments, the preprocessing includes token splitting. In embodiments, the preprocessing further includes normalization.

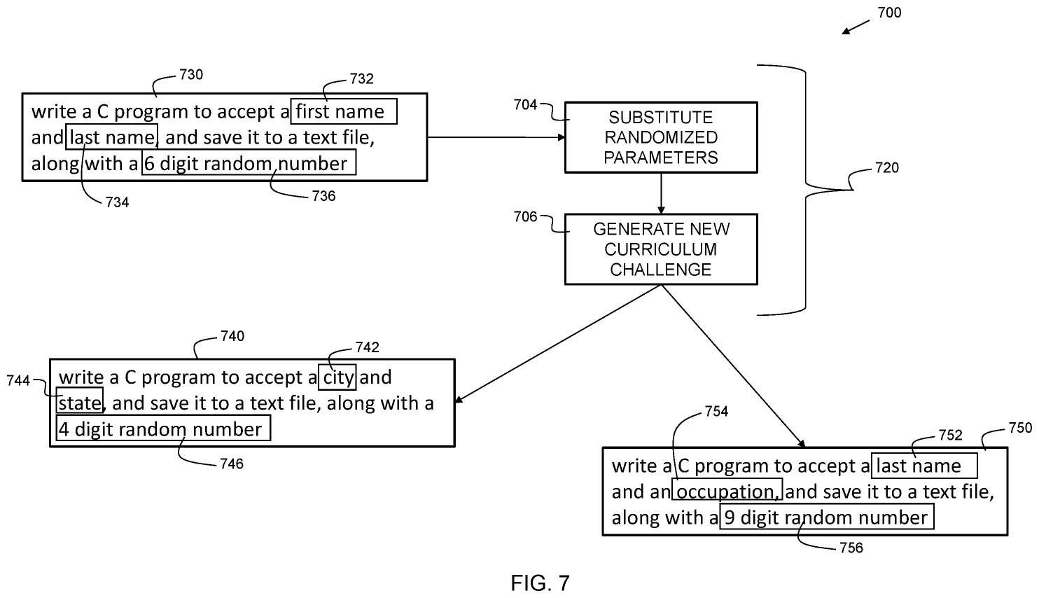

FIG. 7 is an example 700 of parameter randomization. At 730, there is a curriculum challenge. The curriculum challenge 730 includes three parameters; first name 732, last name 734, and random number 736. The process depicted at 720 includes substituting randomized parameters 704, and generating a new curriculum challenge 706. In the example 700, two new curriculum challenges are shown. Curriculum challenge 740 is similar to curriculum challenge 730, but with different parameters substituted. The curriculum challenge 740 includes three parameters; city 742, state 744, and random number 746. In comparing curriculum challenge 740 to curriculum challenge 730, the first name 732 in challenge 730 is replaced with the city 742 in challenge 740. Similarly, the last name 734 in challenge 730 is replaced with the state 744 in challenge 740, and the random number 736 in challenge 730 is six digits, while the random number 746 in challenge 740 is four digits. Similarly, curriculum challenge 750 is similar to curriculum challenge 730, but with different parameters substituted. The curriculum challenge 750 includes three parameters; last name 752, occupation 754, and random number 756. In comparing curriculum challenge 750 to curriculum challenge 730, the first name 732 in challenge 730 is replaced with the last name 752 in challenge 750. Similarly, the last name 734 in challenge 730 is replaced with the occupation 754 in challenge 750, and the random number 736 in challenge 730 is six digits, while the random number 756 in challenge 750 is nine digits. The parameter randomization can generate variations on an initial challenge. Each variation is similar from a problem-solving standpoint, but is not identical. In some embodiments, the randomization can be on a class section level, such that each section of a course is presented with a different challenge variation. In some embodiments, the randomization can be on an individual level, such that each student is presented with a different challenge variation. This serves to reduce the amount of ‘cut and paste’ types of cheating and plagiarizing that can sometimes occur in remote learning environments.

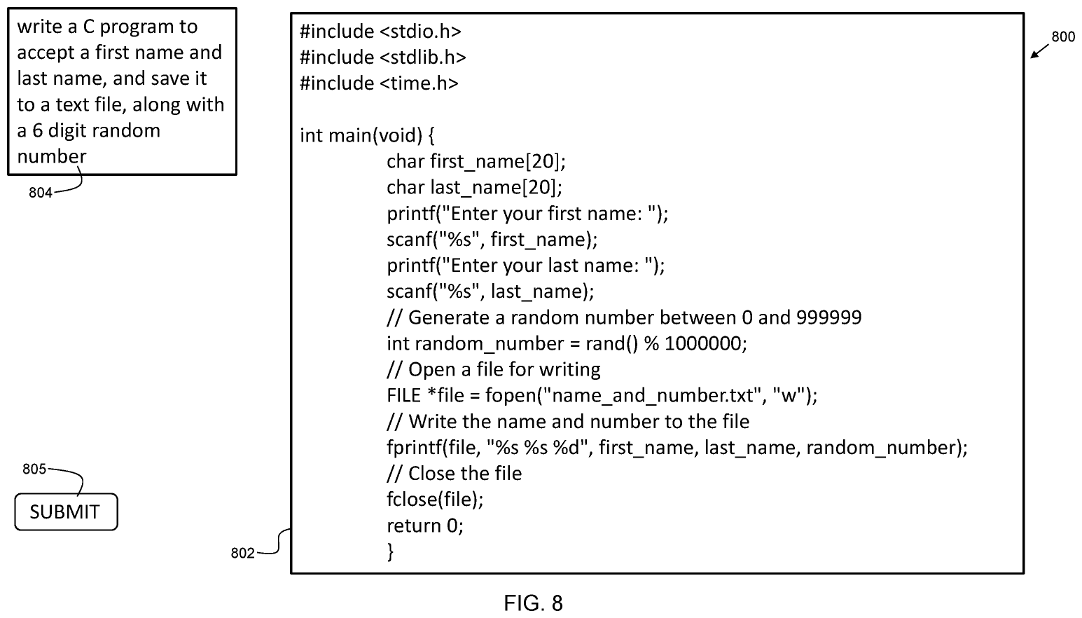

FIG. 8 is an example 800 of a curriculum challenge and corresponding curriculum response. An example challenge is shown at 804, and at 802, there is a code window that includes a curriculum response, in the form of a C program that a user such as a student may submit, in an attempt to respond to the challenge shown at 804. When the user has completed writing the curriculum response, the user invokes the submit button 805, to cause their client device to transmit the source code to the remote learning system (278 of FIG. 2), and/or CCES (202 of FIG. 2).

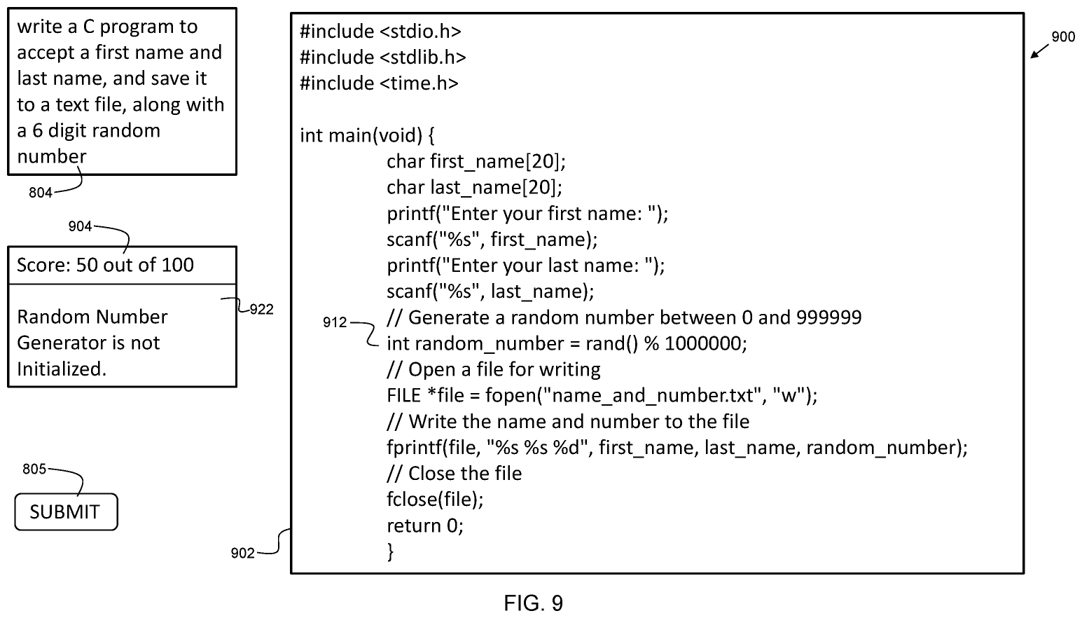

FIG. 9 is an example 900 showing an exemplary score based on the evaluation of the curriculum response of FIG. 7. An example challenge is shown at 804, and at 902, there is a code window that includes a curriculum response, in the form of a C program that a user such as a student may submit, in an attempt to respond to the challenge shown at 804. A score field 904 indicates a score of 50 out of 100. A feedback field 922 provides feedback. In this example, the feedback indicates that the random number generating function in the line indicated at 912 is called without any initialization/seeding of the random number generator.

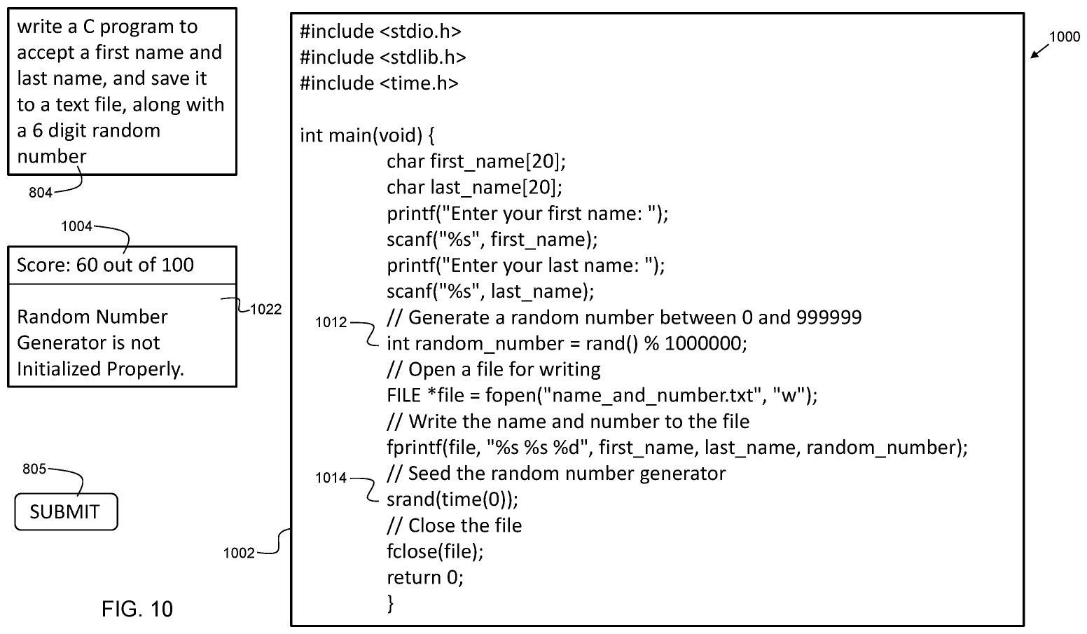

FIG. 10 is an example 1000 showing another exemplary score based on the evaluation of another curriculum response. An example challenge is shown at 804, and at 1002, there is a code window that includes a curriculum response, in the form of a C program that a user such as a student may submit, in an attempt to respond to the challenge shown at 804. A score field 1004 indicates a score of 60 out of 100. A feedback field 1022 provides feedback. In this example, the feedback indicates that the random number generating function is not initialized properly, since the random number generating function is invoked in the line indicated at 1012 prior to the initialization/seeding of the random number generator at line 1014.

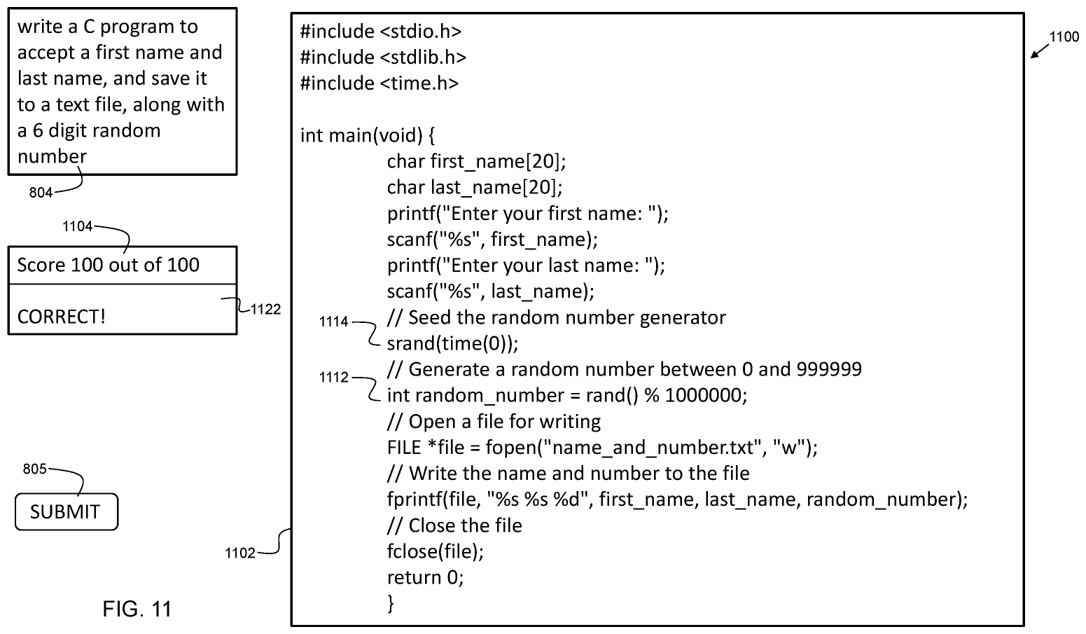

FIG. 11 is an example 1100 showing another exemplary score based on the evaluation of another curriculum response. An example challenge is shown at 804, and at 1102, there is a code window that includes a curriculum response, in the form of a C program that a user such as a student may submit, in an attempt to respond to the challenge shown at 804. A score field 1104 indicates a score of 100 out of 100. A feedback field 1122 provides feedback. In this example, the feedback indicates that the response is correct, since the random number generating function is invoked in the line indicated at 1112 after the initialization/seeding of the random number generator at line 1114.

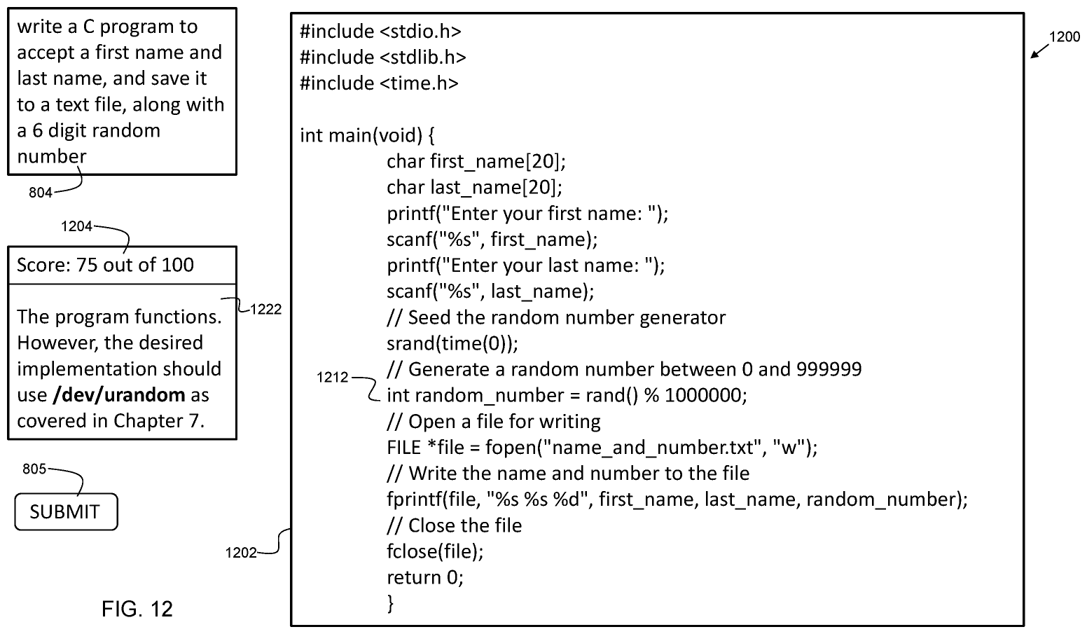

FIG. 12 is an example 1200 showing another exemplary score based on the evaluation of another curriculum response that includes curriculum material. An example challenge is shown at 804, and at 1202, there is a code window that includes a curriculum response, in the form of a C program that a user such as a student may submit, in an attempt to respond to the challenge shown at 804. A score field 1204 indicates a score of 75 out of 100. A feedback field 1222 provides feedback. In this example, the feedback indicates that while the program functions properly, and produces the correct result, it is not an optimal solution, since the random number generating function that is invoked in the line indicated at 1212 is the rand ( ) function, and does not utilize the/dev/urandom technique that is part of the curriculum for the lesson. Embodiments can include deriving at least one curriculum element from the curriculum material; and wherein the score that is generated is based on the at least one curriculum element.

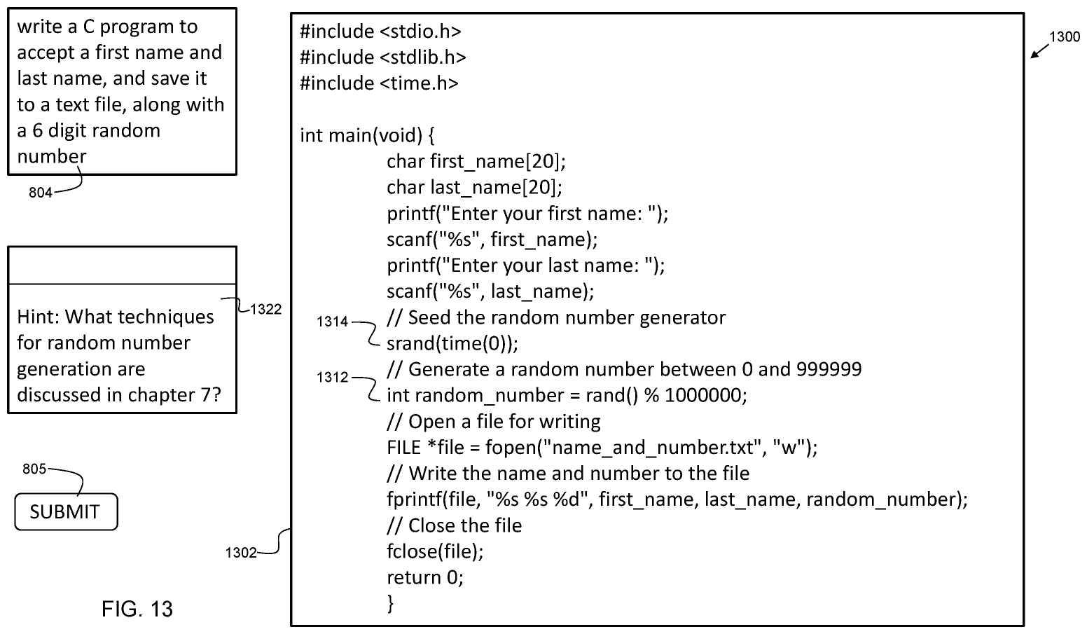

FIG. 13 is an example 1300 illustrating appraisal mode. The appraisal mode can provide hints, suggestions, and/or other feedback prior to the student submitting the challenge. In embodiments, at periodic intervals (e.g., every 5-10 seconds), the contents of the code window 1302 are sent to the remote learning system (278 of FIG. 1), and/or CCES (202 of FIG. 1), for analysis, and feedback is provided to the user interface or portal that the student is using for the challenge. A feedback field 1322 provides feedback. In this example, the feedback is prompting the student to consider the techniques for random numbers that are taught in chapter 7. Although lines 1312 and 1314 indicate a correct implementation for generating random numbers, the feedback indicates it is not the preferred solution, based on the current curriculum being taught. The appraisal mode gives students an opportunity to fix issues and/or make changes prior to submission. The appraisal mode is well-suited for homework problems and quizzes, where it is desired to have the students work through the problems, with the additional help of hints if necessary. Thus, in embodiments, the appraisal mode includes generation and presentation of a hint.

As can now be appreciated, disclosed embodiments provide techniques for automated evaluation and scoring of curriculum challenges such as tests and quizzes. Embodiments use machine learning and AI techniques such as neural networks to analyze submitted code to classify the intent of code for prescribed assignments (curriculum challenges). One or more solutions are input into a neural network for training, which is able to classify not only acceptable and un-acceptable approaches to solving solutions, but also different variants of solutions, providing greater feedback to educators when seeking to provide feedback to students or further refine models. The solutions can be input to the neural network as text, images, and/or other suitable format. Embodiments utilize features such as Convolutional Neural Networks (CNN) for image recognition, Natural Language Processing (NLP) for classification of curriculum content, and Machine Learning on Code (MLonCode) for source code analysis.

Disclosed embodiments serve to assist educators in further refining acceptance criteria, rejected code which produced correct output but uses an unknown type of solution, or a marked-unacceptable solution which has been manually flagged, is placed into a review state, and provided to educators/administrators for undergoing a manual review. Re-classifying this type of solution and using it to re-train a model can help reduce false positives and negatives in this implementation. Thus, disclosed embodiments enable goal-based programming assignments with dynamic inputs and answers which test not only a student's ability to get the right answer, but to write code which demonstrates an understanding of the curriculum being taught.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining curriculum material from a curriculum material corpus;
obtaining challenge material from a challenge corpus;
inputting the curriculum material and the challenge material to a machine learning system;
creating a curriculum grading model based on the machine learning system;
evaluating a curriculum response using the curriculum grading model, and generating a score based on the evaluating.

2. The method of claim 1, wherein the evaluating includes preprocessing of source code.

3. The method of claim 2, wherein the preprocessing includes token splitting.

4. The method of claim 3, wherein the preprocessing further includes normalization.

5. The method of claim 1, wherein the curriculum grading model is based on a plurality of correct solutions and a plurality of incorrect solutions.

6. The method of claim 1, further comprising:
deriving at least one curriculum element from the curriculum material; and
wherein the score that is generated is based on the at least one curriculum element.

7. The method of claim 1, further comprising performing a parameter randomization on a curriculum challenge.

8. The method of claim 1, wherein the evaluating further comprises performing an input-output test on an executable based on the curriculum response.

9. The method of claim 1, wherein the providing the curriculum challenge for display includes setting a challenge mode.

10. The method of claim 9, wherein setting the challenge mode comprises setting the challenge mode to a testing mode.

11. The method of claim 9, wherein setting the challenge mode comprises setting the challenge mode to an appraisal mode.

12. The method of claim 11, wherein the appraisal mode includes generation and presentation of a hint.

13. The method of claim 1, wherein the curriculum material corpus includes text.

14. The method of claim 1, wherein the curriculum material corpus includes audio.

15. The method of claim 1, wherein the curriculum material corpus includes at least one image.

16. An electronic computation device comprising:
a processor;
a memory coupled to the processor, the memory containing instructions, that when executed by the processor, cause the electronic computation device to:
obtain curriculum material from a curriculum material corpus;
obtain challenge material from a challenge corpus;
input the curriculum material and the challenge material to a machine learning system;
create a curriculum grading model based on the machine learning system;
evaluate a curriculum response using the curriculum grading model; and
generate a score based on the evaluating.

17. The electronic computation device of claim 16, wherein the memory further comprises instructions, that when executed by the processor, cause the electronic computation device to derive at least one curriculum element from the curriculum material, wherein the score that is generated is based on the at least one curriculum element.

18. The electronic computation device of claim 16, wherein the memory further comprises instructions, that when executed by the processor, cause the electronic computation device to perform a parameter randomization on the curriculum challenge.

19. A computer program product for an electronic computation device comprising a computer readable storage medium having program instructions embodied therewith, the program instructions executable by a processor to cause the electronic computation device to:
obtain curriculum material from a curriculum material corpus;
obtain challenge material from a challenge corpus;
input the curriculum material and the challenge material to a machine learning system;
create a curriculum grading model based on the machine learning system;
evaluate a curriculum response using the curriculum grading model; and
generate a score based on the evaluating.

20. The computer program product of claim 19, wherein the computer readable storage medium further comprises program instructions, that when executed by the processor, cause the electronic computation device to derive at least one curriculum element from the curriculum material, wherein the score that is generated is based on the at least one curriculum element.
